(19) United States
(12) Patent Application Publication
(10) Pub. No.: US 2008/0012807 A1
(43) Pub. Date: Jan. 17, 2008

(54) Liquid Crystal Display

(75) Inventors: Min-Feng Chiang, Hsin-Chu (TW); Hsueh-Ying Huang, Hsin-Chu (TW); Ming-Sheng Lai, Hsin-Chu (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: AU OPTRONICS CORPORATION, Hsin-Chu (TW)

(21) Appl. No.: 11/765,053

(22) Filed: Jun. 19, 2007

(30) Foreign Application Priority Data
Jul. 13, 2006 (TW) 95125728

(51) Int. Cl. G09G 3/36; G09G 5/00

(52) U.S. Cl. 345/87; 345/205

(57) ABSTRACT

A liquid crystal display includes a plurality of scan lines arranged in parallel, a plurality of data lines arranged in parallel and crossing the scan lines, and a plurality of switching devices respectively formed in the locations of the scan lines crossing the data lines, the switching devices connected with same scan line are arranged on the two sides of the scan line and are located in the corresponding pixel respectively, wherein each pixel includes two switching devices and one switching device is connected to the corresponding data line through the other switching device.

### RELATED APPLICATIONS

This application claims priority to Taiwan Application Serial Number 95125728, filed Jul. 13, 2006, which is herein incorporated by reference.

### FIELD OF THE INVENTION

The present invention relates to a liquid crystal display, and more particularly, to a liquid crystal display with improved view angles.

### BACKGROUND OF THE INVENTION

Liquid crystal displays have been used in various electronic devices. A Multi-Domain Vertically Aligned Mode (MVA mode) liquid crystal display was developed by Fujitsu in 1997 to provide a wider viewing range. In the MVA mode, a 160 degree view angle and a high response speed was achieved. However, when a user looks at this LCD from the oblique direction, the skin color of Asian people (light orange or pink) appears bluish or whitish. Such a phenomenon is called color shift.

The transmittance-voltage (T-V) characteristic of the MVA mode liquid crystal display is shown in FIG. 1. The vertical axis is the transmittance rate. The horizontal axis is the applied voltage. When the applied voltage is increased, the transmittance rate curve 101 in the normal direction is also increased. The transmittance changes monotonically as the applied voltage increases. In the oblique direction, the transmittance rate curve 102 winds and the various gray scales become the same. However, in the region 100, when the applied voltage is increased, the transmittance rate curve 102 is not increased. That is the reason why the color shifts.

A method is provided to improve the foregoing problem. According to the method, a pixel unit is divided into two sub pixels. The two sub pixels may generate two different T-V characteristics. By combining the two different T-V characteristics, a monotonic T-V characteristic can be realized. The line 201 in FIG. 2 shows the T-V characteristic of a sub-pixel. The line 202 in FIG. 2 shows the T-V characteristic of another sub-pixel. By combining the two different T-V characteristics of line 201 and line 202, a monotonic T-V characteristic can be realized, as shown by the line 203 in FIG. 2. Therefore, a pixel unit with two sub pixels and drive method thereof is required.

### SUMMARY OF THE INVENTION

One object of the present invention is to provide a liquid crystal display with a wide view angle.

Another object of the present invention is to provide a pixel with two sub pixels.

One aspect of the present invention is directed to a liquid crystal display with a plurality of pixel unit that may be driven by a drive wave to form two different pixel electrode voltages in a pixel unit.

Another aspect of the present invention is directed to a method for driving a liquid crystal display with a plurality of pixel unit, wherein each pixel unit has two sub pixels.

According to an embodiment, the present invention provides a liquid crystal display, comprising: a plurality of data lines arranged in parallel to each other; a plurality of scan lines arranged in parallel to each other and crossing the data lines; and a plurality of switching devices respectively formed in the locations of the scan lines crossing the data lines, the switching devices connected with same scan lines are arranged on the two sides of a scan line and located in a corresponding pixel respectively, wherein each pixel includes two switching devices where one switching device is connected to the corresponding data line through another switching device.

According to another embodiment, the liquid crystal display further comprises a plurality pixel electrodes connected to the switching devices respectively.

According to another embodiment, the liquid crystal display further comprises a plurality of common electrodes, wherein the common electrodes and the scan lines are alternatively arranged.

According to another embodiment, the present invention provides a liquid crystal display, comprising: a plurality of scan lines arranged in parallel to each other; a plurality of data lines arranged in parallel to each other and crossing the data lines, wherein adjacent first data line and second data line and adjacent first scan line and second scan line define a pixel, wherein each pixel further comprises: a pixel electrode; a first transistor with a gate electrode connected to the first scan line, a first source/drain electrode and a second source/drain electrode connected to the pixel electrode; and a second transistor with a gate electrode connected to the second scan line, a first source/drain electrode connected to the first data line and a second source/drain electrode connected to the pixel electrode and the first transistor's first source/drain electrode.

According to another embodiment, the present invention provides a method for driving the foregoing liquid crystal display, the method comprises: providing a dual pulse signal to the scan lines sequentially, wherein the dual pulse signal includes a first pulse signal and a second pulse signal, and the first pulse signal is sent to the second scan line when the second pulse signal is sent to the first scan line; and provides a two-step signal to the data lines sequentially, the two-step signal includes a first voltage signal and a second voltage signal, wherein the first voltage signal is written to the first sub-pixel and the second sub-pixel through the first transistor and the second transistor when the first scan line is driven by the second pulse signal and the second scan line is driven by the first pulse signal, and the second voltage signal is written to the second sub-pixel through the second transistor when the first scan line is not driven and the second scan line is driven by the second pulse signal.

Accordingly, a pixel unit in the present invention is divided into two sub-pixels. Each sub-pixel includes a thin film transistor, a liquid crystal capacitor and a storage capacitor. The two transistors in a pixel are connected to different scan lines. One of the two transistors is connected to the data line through another transistor. Therefore, two different pixel voltages are formed in a pixel. The color shift phenomenon may be eased by combining the two pixel voltages in a pixel.

### BRIEF DESCRIPTION OF THE DRAWINGS

The foregoing aspects and many of the attendant advantages of this invention are more readily appreciated and better understood by referencing the following detailed description, when taken in conjunction with the accompanying drawings, wherein:

FIGS. 1 and 2 illustrate the transmittance-voltage (T-V) characteristic of an MVA mode liquid crystal display;

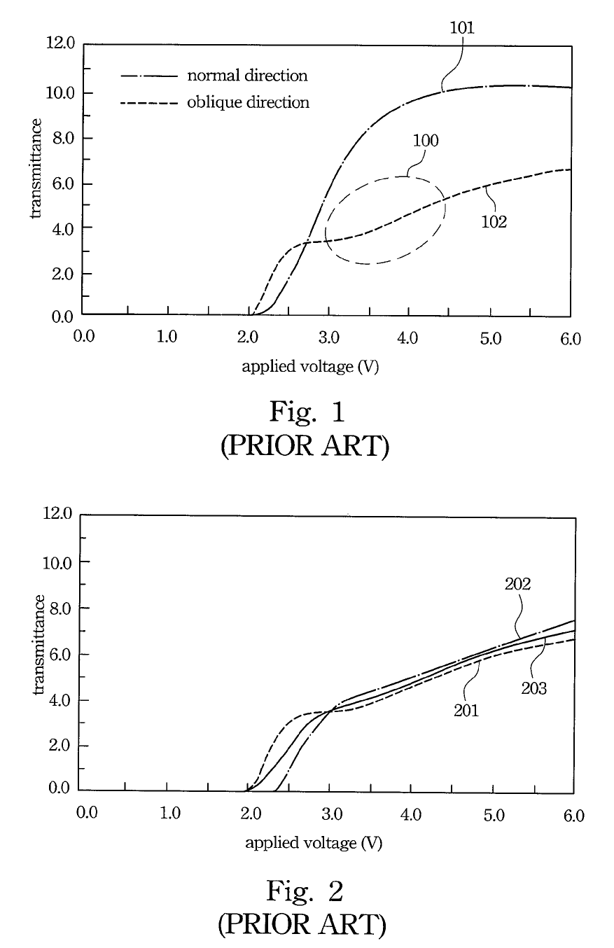

FIG. 3A illustrates a top view of a liquid crystal display according to the first embodiment of the present invention.

FIG. 3B illustrates an enlarged schematic diagram of a pixel unit according to the first embodiment the present invention.

FIG. 4 illustrates a drive waveform and the corresponding electric voltage of four adjacent sub pixels according to an embodiment of the present invention.

FIG. 5 illustrates a drive waveform and the corresponding electric voltage of four adjacent sub pixels according to another embodiment of the present invention.

### DETAILED DESCRIPTION OF THE PREFERRED EMBODIMENT

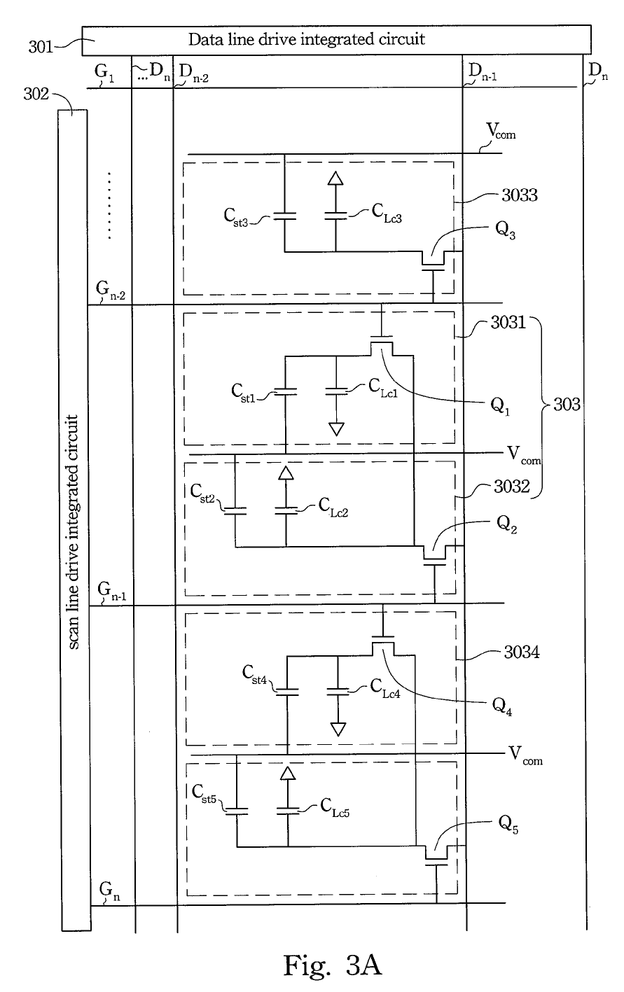

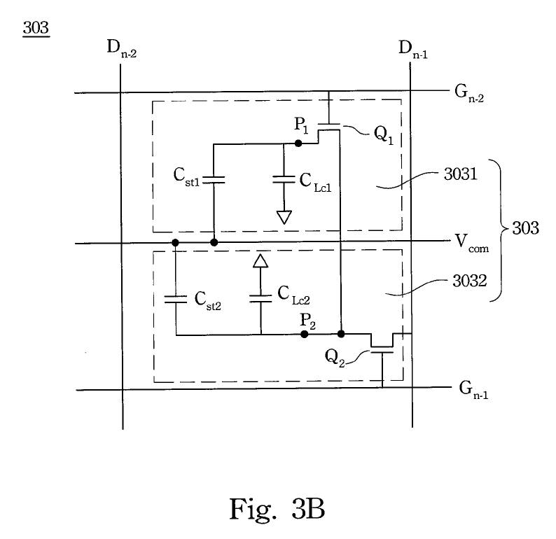

FIG. 3A illustrates a top view of a liquid crystal display according to the first embodiment of the present invention. The liquid crystal display is composed of data lines D1, D2, D3, . . . , Dn and scan lines G1, G2, G3, . . . , Gn. The data lines and the scan lines are substantially perpendicular to each other. An adjacent data line and scan line define a pixel unit 303. Each pixel unit includes a common electrode V_{com} substantially parallel to the scan line. According to the present invention, the pixel unit 303 includes two sub-pixels 3031 and 3032. Each sub-pixel 3031 or 3032 includes a storage capacitor Cst, a liquid crystal capacitor Clc and a thin film transistor. The storage capacitor Cst is composed of the pixel electrode and the common electrode. The liquid crystal capacitor is composed of the pixel electrode and the conductive electrode in the upper substrate (not shown in figure). The thin film transistor is formed near the location that the data line crosses the scan line. A data line drive integrated circuit 301 is used to control the data lines D1, D2, D3, . . . , Dn. A scan line drive integrated circuit 302 is used to control the scan lines G1, G2, G3, . . . , Gn.

The storage capacitors and the liquid crystal capacitors in the sub pixels described in the following are indicated by different symbols. These symbols are not related to their capacitance.

FIG. 3B illustrates an enlarged diagram of a pixel. The pixel 303 is defined by the data lines Dₙ₋₂, Dₙ₋₁ and the scan lines Gₙ₋₂, Gₙ₋₁. A common electrode V_{com} parallel to the scan line is placed between the scan line Gₙ₋₂ and the scan line Gₙ₋₁. The pixel 303 is divided into two sub pixels. The sub pixel 3031 is located between the scan line Gₙ₋₁ and the common electrode V_{com}. The sub pixel 3032 is located between the scan line Gₙ₋₂ and the common electrode V_{com}.

The sub-pixel 3031 includes a thin film transistor Q₁. According to the thin film transistor Q₁, the gate electrode is connected to the scan line Gₙ₋₂, the first source/drain electrode is connected to the data line Dₙ₋₁ through the thin film transistor Q₂ located in the sub-pixel 3032 and the second source/drain electrode is connected to the pixel electrode P₁. The storage capacitor Cₛₜ₁ is composed of the pixel electrode P₁ and the common electrode V_{com}. The liquid crystal capacitor C_{LC1} is composed of the pixel electrode P₁ and the conductive electrode in the upper substrate (not shown in figure).

The sub-pixel 3032 also includes a thin film transistor Q₂. According to the thin film transistor Q₂, the gate electrode is connected to the scan line Gₙ₋₁, the first source/drain electrode is connected to the data line Dₙ₋₁ and the second source/drain electrode is connected to the pixel electrode P₂. The storage capacitor Cₛₜ₂ is composed of the pixel electrode P₂ and the common electrode V_{com}. The liquid crystal capacitor C_{LC2} is composed of the pixel electrode P₁ and the conductive electrode in the upper substrate (not shown in figure).

The thin film transistor Q₁ and the thin film transistor Q₂ act as switches. When a scan voltage is applied to the gate electrode of a thin film transistor, the data voltage in the data line is transferred to the second source/drain electrode and is written into the storage capacitor and the liquid crystal capacitor. In this invention, the thin film transistor Q₁ is not directly connected to the data line Dₙ₋₁. This thin film transistor Q₁ is connected to the data line Dₙ₋₁ through the thin film transistor Q₂. Therefore, when data is written into the storage capacitor Cₛₜ₁ and the liquid crystal capacitor C_{LC1}, the thin film transistor Q₁ and the thin film transistor Q₂ have to be conducted together. Accordingly, in the present invention, a voltage waveform in the scan line is used to control the thin film transistor Q₁ and the thin film transistor Q₂ and co-operates with the voltage waveform in the data line to make the two sub-pixels 3031 and 3032 have different pixel voltages.

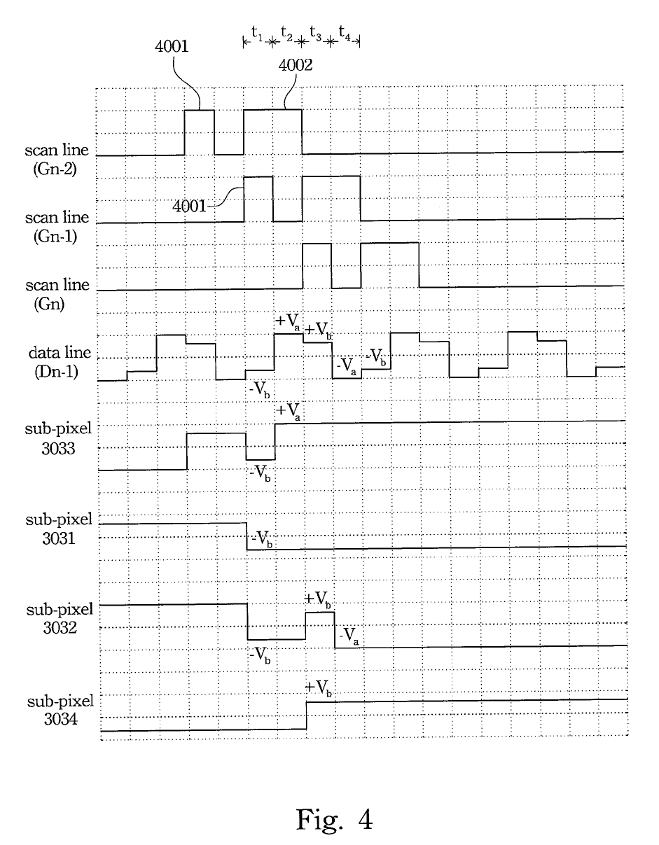

FIG. 4 illustrates a drive waveform and the corresponding electric voltage of four adjacent sub pixels according to an embodiment of the present invention. The drive waveform of the scan line is a dual pulsetype. The pulse width of the first pulse 4001 is less than the pulse width of the second pulse 4002. In an embodiment, the pulse width of the first pulse 4001 is half the pulse width of the second pulse 4002. The distance between the first pulse 4001 and the second pulse 4002 is equal to the pulse width of the first pulse 4001. When scanning, the two drive waveforms output from adjacent scan lines may partially overlap. In this embodiment, the first pulse 4001 of the drive waveform output from one of the adjacent two scan lines may overlap the second pulse 4002 of the drive waveform output from the other scan line. In other words, the transistors connected with the two scan lines are conducted together in this case. The drive waveform of the data line is a two step drive waveform. The positive part of this drive waveform includes two drive voltage Va and Vb. The negative part of this drive waveform also includes two drive voltage −Va and −Vb. The absolute value of the drive voltage Va is larger than the absolute value of the drive voltage Vb.

Referring to the FIG. 3A and FIG. 4, during the time segment T1, the voltage state of both the scan line Gₙ₋₁ and Gₙ₋₂ are in a high level state. The voltage state of scan line Gₙ is in a low level state. Therefore, the transistor Q1, Q₂, Q₃ and Q₄ are turned on and the transistor Q₅ is turned off. In this case, the voltage −Vb in the data line Dₙ₋₁ may charge the liquid crystal capacitors C_{LC2}, C_{LC3} and the storage capacitors Cₛₜ₂, Cₛₜ₃ through the transistor Q2 and Q₃. At this time, the sub-pixel 3032 and the sub-pixel 3033 may present the pixel voltage, −Vb. The transistor Q₁ is connected to the data line Dₙ₋₁ through the transistor Q₂. Therefore, the voltage −Vb in the data line Dₙ₋₁ may charge the liquid crystal capacitors C_{LC1} and the storage capacitors Cₛₜ₁ through the transistor Q2 and Q₁. At this time, the sub-pixel 3031 may also present the pixel voltage, −Vb. The transistors Q₄ is connected to the data line Dₙ₋₁ through the transistors Q₅. The liquid crystal capacitors C_{LC4} and the storage capacitor Cₛₜ₄ are not charged by the voltage −Vb because the the transistor Q₅ is turned off. Therefore, the sub-pixel 3034 presents a pixel voltage with a low level state.

During the time segment T2, the voltage state of the scan line Gₙ₋₂ is in a high level state. The voltage state of scan lines Gₙ and Gₙ₋₁ are in a low level state. Therefore, the transistor Q1 and Q₃ are turned on and the transistor Q2, Q₄ and Q₅ are turned off. In this case, the voltage +Va in the data line Dₙ₋₁ may charge the liquid crystal capacitor C_{LC3} and the storage capacitor Cₛₜ₃ through the transistor Q₃. At this time, the sub-pixel 3033 may present the pixel voltage, +Va. The transistor Q1 is connected to the data line Dₙ₋₁ through the transistor Q2. Because the transistor Q₂ is turned off, the liquid crystal capacitors C_{LC1} and C_{LC2} and the storage capacitors Cₛₜ₁ and Cₛₜ₂ are not charged with the voltage +Va. At this time, the sub-pixel 3031 and the sub-pixel 3032 still present the pixel voltage, −Vb. On the other hand, because the transistor Q₄ is turned off, the liquid crystal capacitors C_{LC4} and the storage capacitors C_{St4} are also not charged with the voltage +Va. At this time, the sub-pixel 3034 still presents a pixel voltage with low level state.

During the time segment T3, the voltage state of the scan line Gₙ₋₂ is in a low level state. The voltage state of the scan lines Gₙ and Gₙ₋₁ are in a high level state. Therefore, the transistors Q1 and Q₃ are turned off and the transistors Q2, Q₄ and Q₅ are turned on. In this case, the voltage +Vb in the data line Dₙ₋₁ may charge the liquid crystal capacitor C_{LC2} and the storage capacitor Cₛₜ₂ through the transistors Q2 and Q₅. At this time, the sub-pixel 3032 may present the pixel voltage, +Vb. Because the transistor Q₁ is turned off, the liquid crystal capacitors C_{LC1} and the storage capacitors Cₛₜ₁ are not charged by the voltage +Vb. At this time, the sub-pixel 3031 still present the pixel voltage, −Vb. On the other hand, because the transistor Q₃ is turned off, the liquid crystal capacitors C_{LC3} and the storage capacitors C_{St3} are not charged by the voltage +Vb. At this time, the sub-pixel 3033 still presents the pixel voltage, +Va. The transistors Q₄ is connected to the data line Dₙ₋₁ through the transistors Q₅. Therefore, the liquid crystal capacitor C_{LC4} and the storage capacitor C_{St4} are charged by the voltage +Vb. At this time, the sub-pixel 3034 presents a pixel voltage, +Vb.

During the time segment T4, the voltage state of the scan line Gₙ and Gₙ₋₂ are in a low level state. The voltage state of the scan line Gₙ₋₁ is in a high level state. Therefore, the transistors Q1, Q₃ and Q₅ are turned off and the transistors Q2 and Q₄ are turned on. In this case, the voltage −Va in the data line Dₙ₋₁ may charge the liquid crystal capacitor C_{LC2} and the storage capacitor Cₛₜ₂ through the transistor Q₂. At this time, the sub-pixel 3032 may present the pixel voltage, −Va. Because the transistor Q₁ is turned off, the liquid crystal capacitors C_{LC1} and the storage capacitors C_{St1} are not charged by the voltage −Va. At this time, the sub-pixel 3031 still presents the pixel voltage, −Vb. On the other hand, because the transistor Q₃ is turned off, the liquid crystal capacitors C_{LC3} and the storage capacitors C_{St3} are not charged by the voltage −Va. At this time, the sub-pixel 3033 still presents the pixel voltage, +Va. The transistor Q₄ is connected to the data line Dₙ₋₁ through the transistors Q₅. Because the transistor Q₅ is turned off, the liquid crystal capacitor C_{LC4} and the storage capacitor C_{St4} are not charged by the voltage −Va. At this time, the sub-pixel 3034 still presents a pixel voltage, +Vb.

Accordingly, from the time segment T1 to T4, at least two pixel voltages, −Vb and +Va, are presented in the pixel 303 together. Different pixel voltage may present different optical characteristics. Therefore, the color shift phenomenon may be eased by combining the two pixel voltages in a pixel.

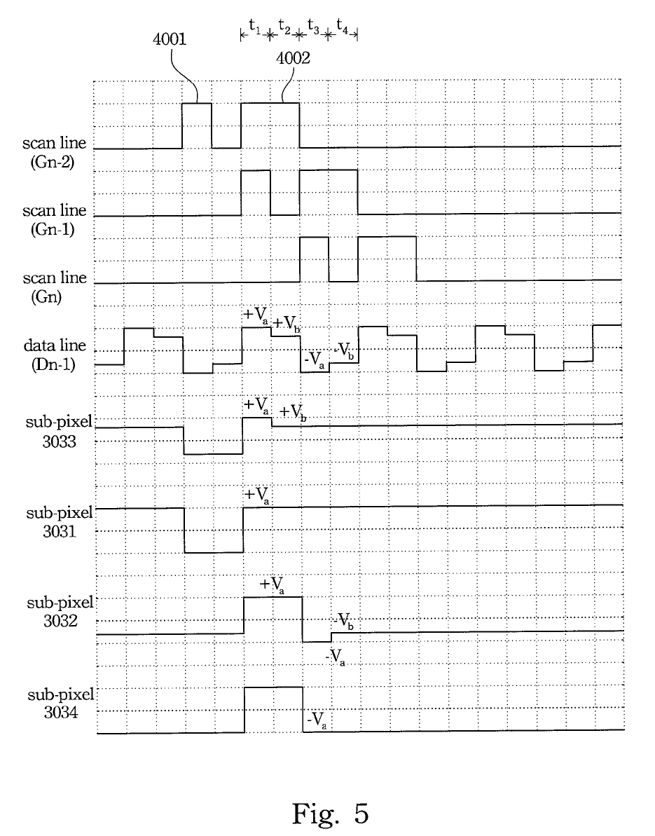

FIG. 5 illustrates a drive waveform and the corresponding electric voltage of four adjacent sub pixels according to another embodiment of the present invention. In this embodiment, the optical characteristic compensation is performed by combining the optical characteristics of the two sub-pixels respectively located on the two sides of a scan line. For example, in the FIG. 3A, the optical characteristics of the two sub-pixels 3033 and 3031 respectively located on the two sides of the the scan line Gₙ₋₂ are combined to ease the color shift phenomenon.

In this embodiment, the drive waveform of the scan line is also a dual-pulse type. The pulse width of the first pulse 4001 is less than the pulse width of the second pulse 4002. In an embodiment, the pulse width of the first pulse 4001 is half of the pulse width of the second pulse 4002. The distance between the first pulse 4001 and the second pulse 4002 is equal to the pulse width of the first pulse 4001. When scanning, the two drive waveforms output from adjacent scan lines may partially overlap. In this embodiment, the first pulse 4001 of the drive waveform output from one of the adjacent two scan lines may overlap the second pulse 4002 of the drive waveform output from the other scan line. The drive waveform of the data line is a two step drive waveform. The positive part of this drive waveform includes two drive voltage Va and Vb. The negative part of this drive waveform also includes two drive voltage −Va and −Vb. The absolute value of the drive voltage Va is larger than the absolute value of the drive voltage Vb. Comparing with the FIG. 4, the drive waveform of this embodiment is prior to the drive waveform in the FIG. 4 by a time segment T1.

Referring to the FIG. 3A and FIG. 5. During the time segment T1, the voltage state of both the scan line Gₙ₋₁ and Gₙ₋₂ are in a high level state. The voltage state of scan line Gₙ is in a low level state. Therefore, the transistors Q₁, Q₂, Q₃ and Q₄ are turned on and the transistor Q₅ is turned off. In this case, the voltage +Va in the data line Dₙ₋₁ may charge the liquid crystal capacitors C_{LC2}, C_{LC3} and the storage capacitors Cₛₜ₂, Cst₃ through the transistors Q₂ and Q₃. At this time, the sub-pixel 3032 and the sub-pixel 3033 may present the pixel voltage, +Va. The transistor Q₁ is connected to the data line Dₙ₋₁ through the transistor Q₂. Therefore, the voltage +Va in the data line Dₙ₋₁ may charge the liquid crystal capacitors C_{LC1} and the storage capacitors Cₛₜ₁ through the transistor Q2 and Q₁. At this time, the sub-pixel 3031 may also present the pixel voltage, +Va. The transistors Q₄ is connected to the data line Dₙ₋₁ through the transistors Q₅. The liquid crystal capacitors C_{LC4} and the storage capacitor C_{st 4} are not charged by the voltage +Va because the transistor Q₅ is turned off. Therefore, the sub-pixel 3034 presents a pixel voltage the same as the prior voltage state, +Va.

During the time segment T2, the voltage state of the scan line Gₙ₋₂ is in a high level state. The voltage state of scan lines Gₙ and Gₙ₋₁ are in a low level state. Therefore, the transistors Q₁ and Q₃ are turned on and the transistors Q₂, Q₄ and Q₅ are turned off. In this case, the voltage +Vb in the data line Dₙ₋₁ may charge the liquid crystal capacitor C_{LC3} and the storage capacitor Cₛₜ₃ through the transistor Q₃. At this time, the sub-pixel 3033 may present the pixel voltage, +Vb. The transistor Q₁ is connected to the data line Dₙ₋₁ through the transistor Q₂. Because the transistor Q₂ is turned off, the liquid crystal capacitors C_{LC1} and C_{LC2} and the storage capacitors C_{St1} and Cₛₜ₂ are not charged by the voltage +Vb. At this time, the sub-pixel 3031 and the sub-pixel 3032 still present the pixel voltage, +Va. On the other hand, because the transistor Q₄ is turned off, the liquid crystal capacitors C_{LC4} and the storage capacitors C_{St4} are also not charged by the voltage +Vb. At this time, the sub-pixel 3034 still presents a pixel voltage with a low level state.

During the time segment T3, the voltage state of the scan line Gₙ₋₂ is in a low level state. The voltage state of scan lines Gₙ and Gₙ₋₁ are in a high level state. Therefore, the transistors Q₁ and Q₃ are turned off and the transistors Q₂, Q₄ and Q₅ are turned on. In this case, the voltage −Va in the data line Dₙ₋₁ may charge the liquid crystal capacitor C_{LC2} and the storage capacitor Cₛₜ₂ through the transistors Q₂ and Q₅. At this time, the sub-pixel 3032 may present the pixel voltage, −Va. Because the transistor Q₁ is turned off, the liquid crystal capacitors C_{LC1} and the storage capacitors C_{St1} are not charged by the voltage −Va. At this time, the sub-pixel 3031 still presents the pixel voltage, +Va. On the other hand, because the transistor Q₃ is turned off, the liquid crystal capacitors C_{LC3} and the storage capacitors C_{St3} are not charged by the voltage −Va. At this time, the sub-pixel 3033 still presents the pixel voltage, +Vb. The transistors Q₄ is connected to the data line Dₙ₋₁ through the transistors Q₅. Therefore, the liquid crystal capacitor C_{LC4} and the storage capacitor C_{St4} are charged by the voltage −Va. At this time, the sub-pixel 3034 presents a pixel voltage, −Va.

During the time segment T4, the voltage state of the scan line Gₙ and Gₙ₋₂ are in a low level state. The voltage state of scan lines Gₙ₋₁ is in a high level state. Therefore, the transistors Q₁, Q₃ and Q₅ are turned off and the transistors Q₂ and Q₄ are turned on. In this case, the voltage −Vb in the data line Dₙ₋₁ may charge the liquid crystal capacitor C_{LC2} and the storage capacitor Cₛₜ₂ through the transistor Q₂. At this time, the sub-pixel 3032 may present the pixel voltage, −Vb. Because the transistor Q₁ is turned off, the liquid crystal capacitors C_{LC1} and the storage capacitors C_{St1} are not charged by the voltage −Vb. At this time, the sub-pixel 3031 still presents the pixel voltage, +Va. On the other hand, because the transistor Q₃ is turned off, the liquid crystal capacitors C_{LC3} and the storage capacitors C_{St3} are not charged by the voltage −Vb. At this time, the sub-pixel 3033 still presents the pixel voltage, +Vb. The transistor Q₄ is connected to the data line Dₙ₋₁ through the transistors Q₅. Because the transistor Q₅ is turned off, the liquid crystal capacitor C_{LC4} and the storage capacitor C_{St4} are not charged by the voltage −Vb. At this time, the sub-pixel 3034 still presents a pixel voltage, −Va.

Accordingly, from the time segment T1 to T4, at least two pixel voltages, Vb and Va, are respectively presented in the sub-pixel 3033 and sub-pixel 3031. Different pixel voltage may present different optical characteristics. Therefore, the color shift phenomenon may be eased by combining the two pixel voltages in a pixel.

Accordingly, a pixel unit is divided into two sub-pixels. Each sub-pixel includes a thin film transistor, a liquid crystal capacitor and a storage capacitor. The two transistors in a pixel are connected to different scan lines. One of the two transistors is connected to the data line through another transistor. Therefore, two different pixel voltages are formed in a pixel. The color shift phenomenon may be eased by combining the two pixel voltages in a pixel.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A liquid crystal display having a plurality of gate lines, a plurality of data lines, and a plurality of pixels spatially arranged in a matrix, each pixel being defined between two neighboring gate lines and two neighboring data lines crossing the two neighboring gate lines, comprising:
a plurality of switching devices formed in the pixels, the switching devices electrically connected with the same scan lines being arranged on the two sides of scan lines, wherein each pixel includes at least two switching devices, and one switching device is connected to a corresponding data line through another switching device; and
a plurality of pixel electrodes electrically connected to the switching devices respectively.

2. The liquid crystal display of claim 1, wherein each of the switching devices comprises a transistor.

3. The liquid crystal display of claim 1 further comprising a common electrode, wherein the common electrode and the scan lines are alternately arranged.

4. A liquid crystal display, comprising:
a plurality of scan lines;
a plurality of data lines crossing the scan lines, wherein adjacent first data line and second data line and adjacent first scan line and second scan line define a pixel, wherein each pixel further comprises:
a first sub-pixel electrode;
a second sub-pixel electrode;
a first transistor with a gate electrode electrically connected to the first scan line, a first source/drain electrode and a second source/drain electrode electrically connected to the first sub-pixel electrode; and
a second transistor with a gate electrode electrically connected to the second scan line, a first source/drain electrode electrically connected to the first data line and a second source/drain electrode electrically connected to the second sub-pixel electrode and the first transistor's first source/drain electrode.

5. The liquid crystal display of claim 4, wherein the liquid crystal display further comprises a plurality of common electrodes, wherein the common electrodes and the scan lines are alternatively arranged.

6. The liquid crystal display of claim 4, wherein the data lines are substantially perpendicular to the scan lines.

7. A drive method for driving a liquid crystal display, the liquid crystal display comprising a plurality of scan lines and a plurality of data lines, a plurality of pixels being defined by two neighboring scan lines and two neighboring data lines crossing the two scan lines, each pixel including a first sub-pixel with a first transistor electrically connected to a first scan line and a second sub-pixel with a second transistor electrically connected to a second scan line, and the first transistor being connected to a data line through the second transistor, the method comprises:
providing a dual pulse signal to the scan lines sequentially, wherein the dual pulse signal includes a first pulse signal and a second pulse signal, and the first pulse signal is sent to the second scan line when the second pulse signal is sent to the first scan line; and
providing a two-step signal to the data lines sequentially, the two-step signal including a first voltage signal and a second voltage signal, wherein the first voltage signal is written to the first sub-pixel and the second sub-pixel through the first transistor and the second transistor when the first scan line is driven by the second pulse signal and the second scan line is driven by the first pulse signal, and the second voltage signal is written to the second sub-pixel through the second transistor when the first scan line is not driven and the second scan line is driven by the second pulse signal.

8. The drive method of claim 7, wherein the pulse width of the first pulse signal is less than the pulse width of the second pulse signal.

9. The drive method of claim 7, wherein the pulse width of the first pulse signal is half of the pulse width of the second pulse signal.

10. The drive method of claim 7, wherein the second pulse signal is subsequent to the first pulse signal.

11. The drive method of claim 7, wherein the first voltage signal is less than or equal to the second voltage signal.

12. The drive method of claim 7, wherein the first voltage signal is larger than or equal to the second voltage signal.

13. A drive method for driving a liquid crystal display, wherein the liquid crystal display comprises a plurality of scan lines and a plurality of data lines, adjacent data line and scan line define a pixel, wherein each pixel includes a first sub-pixel with a first transistor electrically connected to a first scan line and a second sub-pixel with a second transistor electrically connected to a second scan line, and the first transistor is electrically connected to a data line through the second transistor, the method comprises:
providing a high level electric potential to the first scan line and the second scan line to write a first voltage signal transferred through the data line to the first sub-pixel and the second sub-pixel; and
providing a low level electric potential to the first scan line and providing a high level electric potential to the second scan line to write a second voltage signal transferred through the data line to the second sub-pixel.

14. The drive method of claim 13, wherein the time for providing a high level electric potential to the first scan line is two times of the time for providing a high level electric potential to the second scan line.

15. The drive method of claim 13, wherein the first voltage signal is less than the second voltage signal.

16. The drive method of claim 13, wherein the first voltage signal is larger than the second voltage signal.
